(19) United States
(12) Patent Application Publication
(10) Pub. No.: US 2013/0191291 A1
(43) Pub. Date: Jul. 25, 2013

(54) Crowd Source Project Management System

(71) Applicant: James Greeson, Columbus, GA (US)

(72) Inventor: James Greeson, Columbus, GA (US)

(21) Appl. No.: 13/358,001

(22) Filed: Jan. 25, 2012

(51) Int. Cl. G06Q 10/06

(52) U.S. Cl. 705/301

(57) ABSTRACT

The present invention provides a system and method for utilizing computer networks to facilitate the creation, management, and equity valuation of decentralized collaborative projects. The crowd source project management system provides methods for participants to start, join, communicate, contribute, and derive an equity share in user defined activities. Methods of the system automate and facilitate the use of project management and planning methodologies on notoriously difficult to coordinate open and peer-to-peer projects. By means of an abstracted point system the valuation and capitalization of crowd sourced projects can be derived for both individual contributors and the entire endeavor.

### BACKGROUND OF THE INVENTION

1. Field of the Invention

The present invention relates to a programmatic means of utilizing computer networks to facilitate the creation, management, and equity valuation of decentralized “crowd sourced” projects. It is an integrated software system that provides a method for participants to start, join, communicate, contribute, and derive an equity share in open collaborative projects and activities.

2. Description of the Prior Art

Collaborative “open source” and “crowd sourced” projects are becoming more common and popular as a means of accomplishing goals. Most often these are performed in an informal adhoc manner, where user contributions are coordinated by email, internet discussion board, or subject specific web site. There are few if any project management tools involved and contributor deliverables and deadlines are often missed because the participants have no incentive other than their interest in the subject matter and desire to see the project completed. The pool of contributors with applicable skills and resources is often very small because the community of people interested in that specific type of project is insular from the awareness of other people who do not share that interest or visit that internet site. It is very difficult to capitalize open collaborative projects because there is rarely any formal planning, participant contributions cannot be quantified to determine the value added to the project, and the percentages of ownership in any resulting products, profits, or intellectual property is often unclearly defined. Some open collaborative projects are successfully conducted, but they rely upon the qualities of the individual people involved instead of a systematic approach.

All available web based systems of open source and crowd sourced project management rely upon the interest and self-motivation of participants and often only have the “carrot” of potential gain as a means of rewarding participation without the “stick” of negative consequences for failure to live up to commitments. There are also few mechanisms to discourage “free-riding”, a situation where participants in a project who do not contribute equally derive an equal share in whatever the outcome of the project is.

Other means and approaches to attracting and facilitating crowd sourced and open sourced participants and resources are oriented towards providing established conventional businesses and organizations access to external labor in a principle and agency model with the crowd sourcing participants serving as subcontractors. Most applications only facilitate online transfer of data or other informational type work. They operate on a business model of providing a “piece-work” division of labor and are not true collaborative or peer-to-peer operating structures.

U.S. Pat. No. 6,952,670 discloses a method and apparatus of facilitating a self-organizing workforce that uses a system of credentials and reputation rankings to gauge and reward the participation of workers. The system allows workers to vote and comment upon solicited ideas in a social networking and message board format. In exchange for their participation in the system, workers receive a variety of credential points based upon the perceived value of the input. These accumulated credentials can then be used to influence the decision making of the group.

The embodiments as described serve primarily as a means of reaching group consensus. While the system allows participants to submit, comment, and vote on ideas, it is still based upon a conventional business model of administrators controlling and arbitrarily awarding rewards for participation. The elaborate credentialing and merit point award system has a great potential to distract from group collaborative effort and become competitive as workers “game” the system for their individual benefit. The system does little to quantify the value of the contributions workers make beyond those of the credential system and does not intrinsically calculate the equity stake each participant has in the overall project.

U.S. Patent Application Number 20100287104 describes a system and method for managing collaboration among users consisting of a computer and file system in which users can submit files associated with a designated project and when deposited by an external deposit authority the said contributor makes a claim for an equity stake in the project. The system then solicits input from the other users and contributors associated with the designated project to vote to approve or reject the claim with a sliding scale of approval threshold.

This method in its described embodiments is limited to electronic file submissions. It has no provisions for accepting or quantifying other forms of contribution such as factors of capital (land, labor, and capital). The method's mechanism of submission acceptance and equity voting is flawed in that the contributors engage in what are essentially negotiations over the equity value of every single submission and each modification of contributions to the project. Each time every stake holder involved must devote time and attention to reviewing the changes and voting on the equity awarded. This is impractical and has great potential to create disagreement among participants and project failure.

### SUMMARY OF THE INVENTION

The present invention is a means of utilizing the Internet or other electronic network transmission protocol to facilitate the creation, management, and assignment of equity value to decentralized “crowd sourced” projects and activities. In one embodiment, the invention provides a method for display, creation, storage, retrieval, and modification of data files and database queries related to the accumulation of information for making equity valuations for entire projects and for individual participant contributions.

In a preferred embodiment of the present invention the user interface is a client-server based programmatic framework in which modular project design and interaction applications are embedded depending on the specific type of project being developed by contributing entities and as new development tools and technologies are created. These said modular software applications can be custom built or third-party software but all have functionality which interacts with the system's project management and equity valuation components.

It is therefore a primary object of the present invention to provide a means of facilitating the creation, development, and capitalization of open sourced and crowd sourced projects in an efficient manner to address the weaknesses and drawbacks of collaborative project management.

It is another object of the present invention to build an easy to use, generic framework for said open sourced and crowd sourced projects to attract a large user base. This is to obtain a wider diversity of skill-sets, attract resources, and to gain economies of scale for individual and collaborative projects that could not be obtained individually.

It is another object of the present invention to create a fair and clearly understood equity sharing model and other rules that all project contributing entities agree to participate under. The automation of the equity sharing model and its means of distributing equity ownership of a project is a means of impartially motivating participation and avoiding user conflicts.

These and other objects of the present invention fully encompass other embodiments that are recognizable to those skilled in the art upon reading the accompanying description, drawings, and claims set forth herein.

### BRIEF DESCRIPTION OF THE DRAWINGS

FIG. 1 is a basic physical entity relationship model of the system.

FIG. 2 is a project lifecycle flow diagram.

FIG. 3 is a diagram of the matrix point accumulation model.

FIG. 4 is a data relationship model of the system.

FIG. 5 is a mockup of a user's project selection screen.

FIG. 6 is a mockup of a user's project interface screen.

FIG. 7 is a system functional flow diagram.

### DETAILED DESCRIPTION OF THE INVENTION

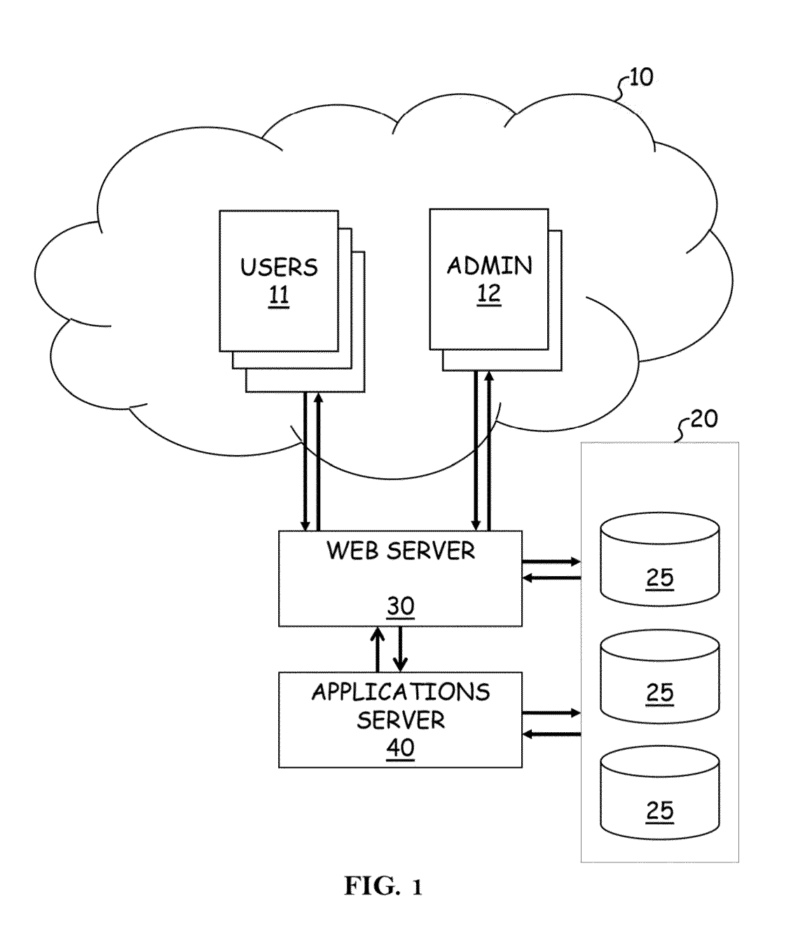

FIG. 1 shows a physical entity relationship model of the best mode contemplated by the inventor of a crowd sourced project management system (hereafter referred to as “the system”) according to the concepts of the present invention. As can be seen amply by those of ordinary skill in the art, the system consists of a plurality of geographically dispersed user participants 11 who interact with the system via the Internet 10 or other electronic network through a web browser running on their local computer device which displays a graphical interface of dynamic HTML files that are generated and transmitted from a central web server 30 which requests data from relevant databases 25 of the database management system 20. This central web server 30 receives data from the plurality of users via graphical interface web page submit actions and writes this information to the databases 25. The web server 30 also requests resources from an applications server 40. The applications server 40 processes commands and file requests related to modular design tools and development software that is then sent to the user participants 11 web browser. The applications server 40 makes query commands to the database management system 20 updating both project related data as well as user participant 11 specific data such as contribution timestamp information and equity valuation adjustments. Similarly, system administrators 12 use a web browser graphical interface to interact with the system and web server 30 root access to perform system manipulation and server and database software maintenance.

There are four functional entities of the system; project creator, project treasurer, project manager, and project contributor. A project creator initiates a new project by creating a project and inputs a new project charter and project plan. The project creator is also responsible for accepting the first few participants into the project and can have overall control and authority over the decision making of the project, depending upon the nature of the project and organizational character chosen for it. The project treasurer is charged with the responsibility with controlling project funds and with the evaluation of both the capital value of participant contributions and the overall project. This role is analogous to the Chief Financial Officer of a conventional organization. Project managers are assigned the responsibility of sub-tasks within a project, the coordination of planning, and other administrative tasks not specifically related to direct work on the project goal. Project contributors are participants of the project who do not have additional duties assigned to them. These roles are not hierarchical relationships, but functional ones. It is recommended that each project have at least two of each “officer” contributor in order to maintain accountability and to provide redundancy in case one cannot make meeting times or has to leave the project as happens often in voluntary, part-time activities.

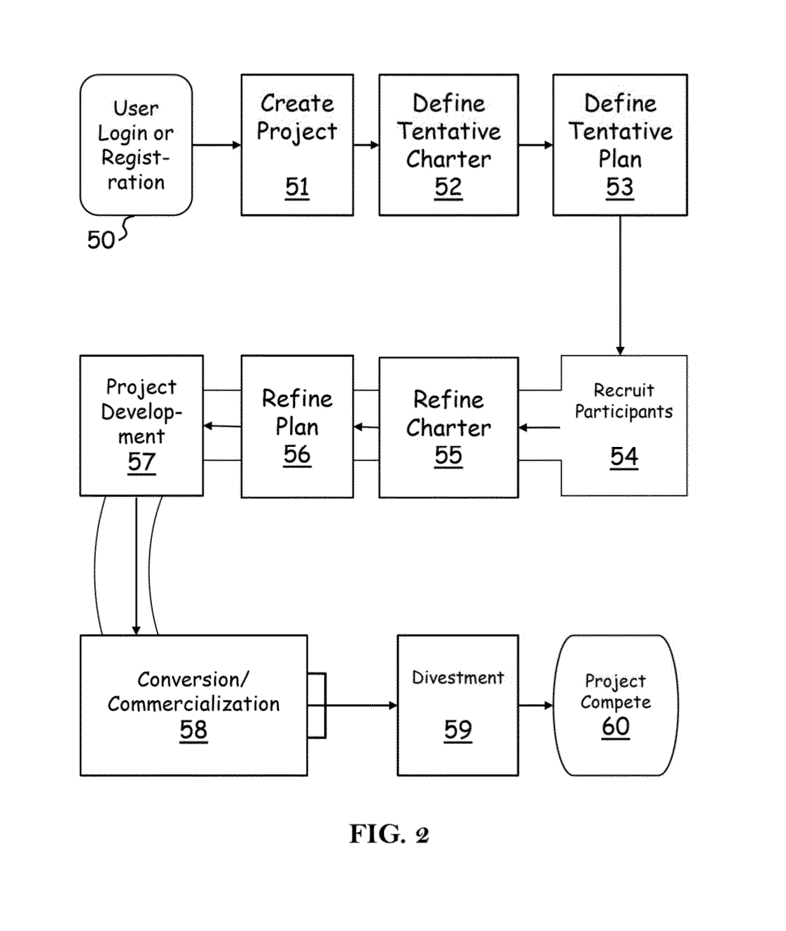

FIG. 2 is a flowchart that shows the preferred embodiment by the inventor of the project creation and lifecycle process of the system. At least one user registers with the system via the login or register process 50 and then creates a new project 51 which requires providing a project name, description, and leads to creating a basic tentative project charter 52 and a tentative project plan 53. The tentative project charter 52 defines the goals of the project, which can be a specific product, service, a process development, or any other user defined objective. The tentative project charter 52 defines the equity point accumulation model to be used during the life of the project. This equity point accumulation model specifies the equity point schedule for events such as users joining the project, user contributions of capital inputs, and the subtraction of equity points as penalties for missing promised deliverable dates or other negative behavior. This equity sharing and accumulation model is of various configurations depending on the nature of the project and its appropriate application and are defined and modified dynamically by users depending on the nature and needs of their individual projects and as the most practical and popular models evolve. The tentative project plan 53 defines the timelines and deliverable deadlines of the project and is referenced with the project charter 52 by the system to determine the timing of equity point additions and penalties. When this is saved to the system database, a project is created and additional contributor users can join the project or be recruited by the project creator during the recruit participants phase 54. The recruit participants phase 54 is continuous during the life of the project to attract new participants and take advantage of new inputs and skills that are useful during different portions of the project development and commercialization phases. When all of the required project officer positions of a project creator, a project treasurer, and at least one project manager are filled, the project charter and project plan can be modified and amended by the participants during the refine project charter phase 55 and refine project plan phase 56 to reach a consensus. Approval from all current participants begins the project development phase 57. At the end of the project development phase 57, the project enters the conversion/commercialization phase 58 where the user contribution inputs are evaluated in relation to the perceived value of the completed goals or deliverables of the project development phase 57. The preceding evaluation assigns the percentage of ownership in the resulting business or the proceeds from the sale of the objects or processes to another external entity. When the project completes the conversion to a conventional business operation, is sold, or otherwise ceases to have any functional use for the system, the project enters the divestment phase 59. The divestment phase 59 is where each contributing entity “close out” the said contributing entity's equity stake, by receiving compensation, products, or equity investments as agreed upon in the project charter, and then electronically signing that they agree with the outcome. When all participants have exchanged their equity share points, and signed the close-out release, the project is complete 60.

One skilled in the art will recognize that a method of voting to derive project contributor consensus and as a means of dispute resolution is an endemic requirement of the open and crowd sourced decentralized model. In one embodiment of the invention, the utilization of the project's contributor equity point totals can be used as a means of quantifying the number or percentage weight of each contributor's vote, analogous to the voting power of shareholders in conventional corporations. But this is not the exclusive method of the embodiment as there are many other variations that may be more suitable to different project types and contributor preferences such as assigned, equal, or no voting power for individual project contributors. The voting model of the project is specified in the Project Charter 55 (FIG. 2).

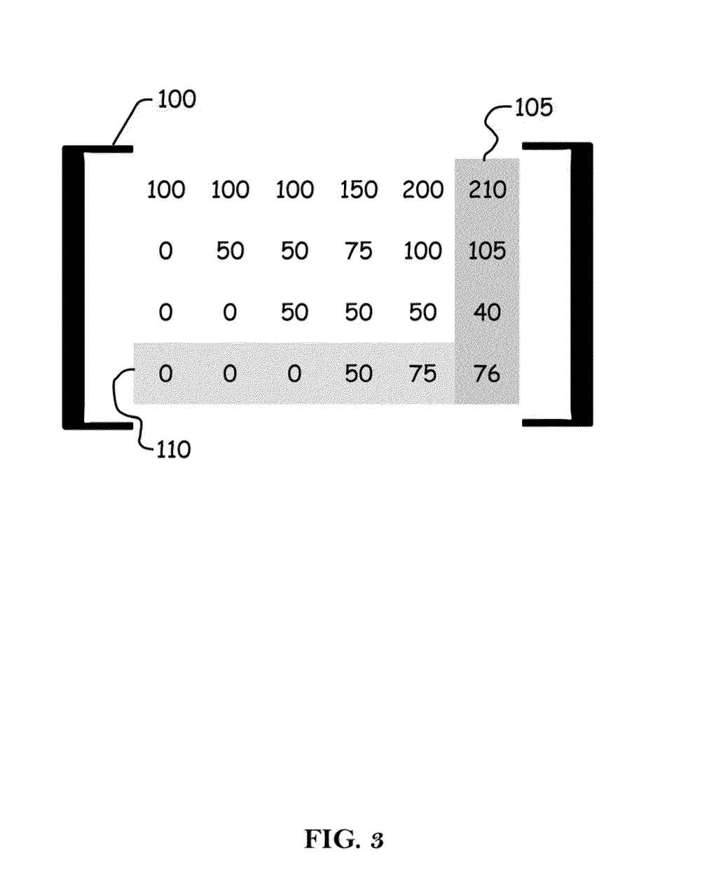

The mathematical mechanism for the tracking and the manipulation of the plurality of contributor equity valuations in each project is via an indefinite linear matrix. As FIG. 3 illustrates, each project has an associated matrix 100 with the column vector 105 representing the accumulation of points of each participant in each “point adjustment event” (any event that causes the point totals of the participants and the overall project to be recalculated). Each row vector 110 represents the total number of participants involved in the project. Each matrix element is the specific adjustment of that participant's point total from an associated project contribution. New participant additions cause a new row vector 110 to be appended to the matrix. New point adjustment events cause a new column vector 105 to be appended to the matrix. This method was chosen because each change in equity can have an effect upon the specific point totals of all participants and the elements can be accessed and manipulated by basic matrix algebra. The matrix schema also facilitates the retention of historical data for audit and statistical analysis purposes. The matrix is stored in the database as a table with a foreign key of the user's identification number and a large text field where the column entries are concatenated with a special character delineation. When a point adjustment event occurs a point adjustment module is called which performs queries on the database that builds the matrices, performs any necessary calculations upon it, and then updates the relevant table entries.

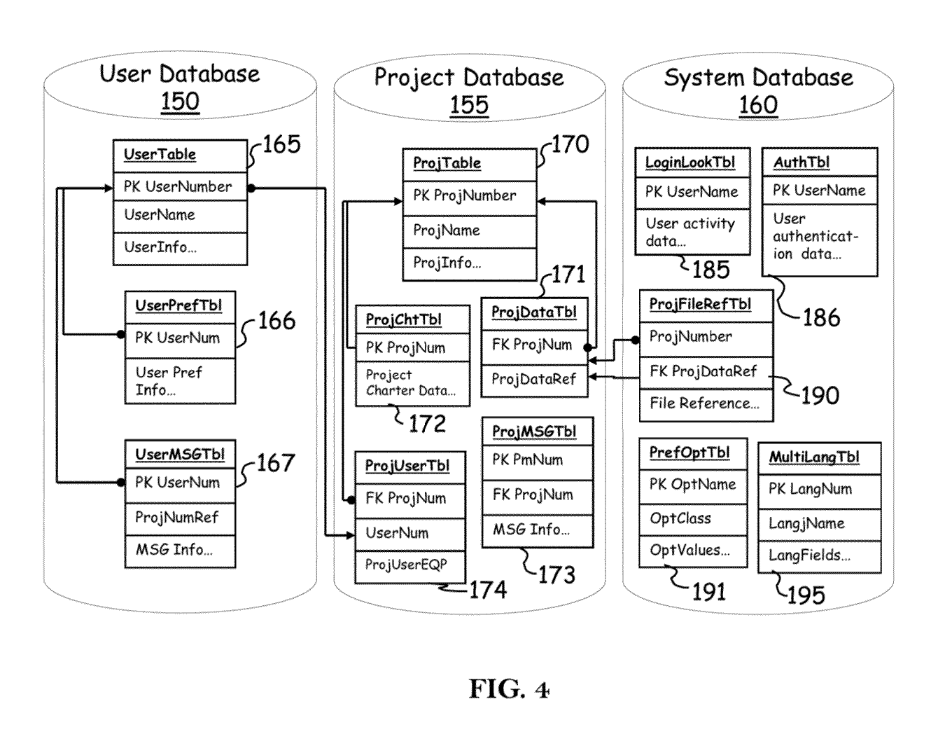

FIG. 4 is a high level data relationship model that depicts the configuration of the data entities of the system with regard to one another in one embodiment. The data structure is comprised of three primary databases; user data 150, project data 155, and system data 160. User Data database 150 tables consist of specific user data stored in the UserTable 165 such as a primary key user number, name fields and other information related to users that is stored in sub-tables. User Data 150 also contains tables related to specific user preference information as a UserPref Table 166 and user specific message records in UserMSG Table 167. The Project Data database 155 consist of project specific data such as the ProjTable 170 with a primary key project number field, project basic information, and references to associated tables such as the project charter and project plan table datasets 172, and a project data table 171 with reference links to files for integrated modular design and development applications 190 that do not use the same data structures. Project specific messaging and other communications related data are stored in a ProjMSG Table 173. A table of contributing users 174 associated with a specific project is referenced to the UserTable 165 in the User Data database 150. The ProjUsers Table 174 is where the project equity point matrix data for that user's contribution are recorded. System data tables 160 consist of system support tables such as user login authorization support tables 185, 186, file location references 190, user display preferences options 191, and utility tables such as web server and applications server utility tables, statistical data tables, and multi-language support 195.

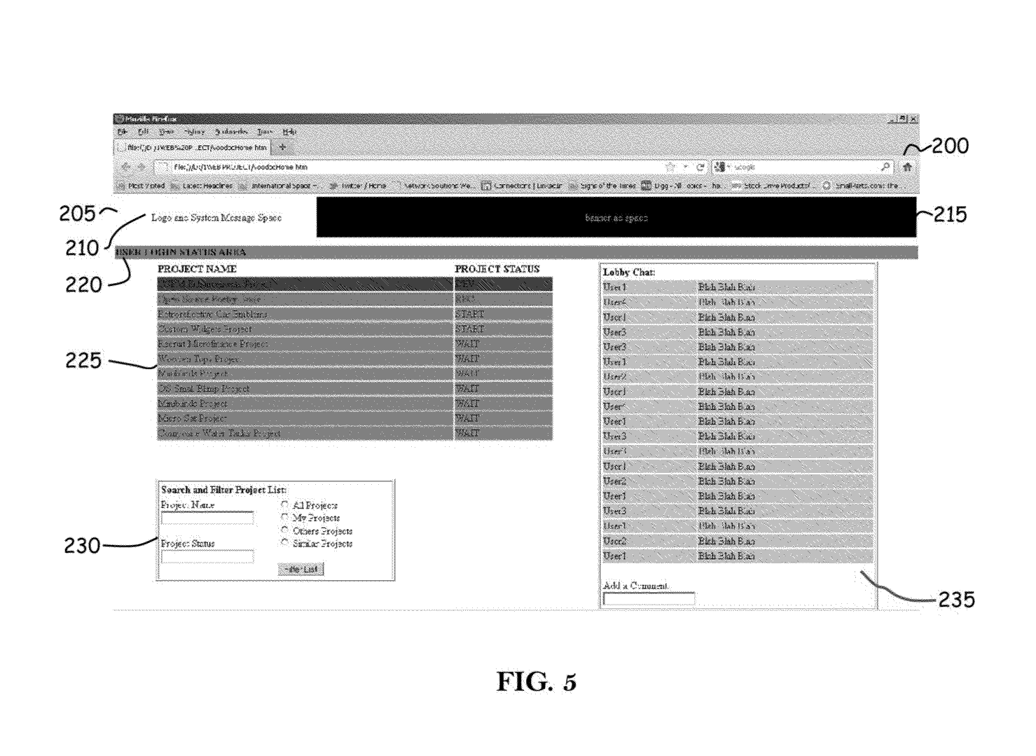

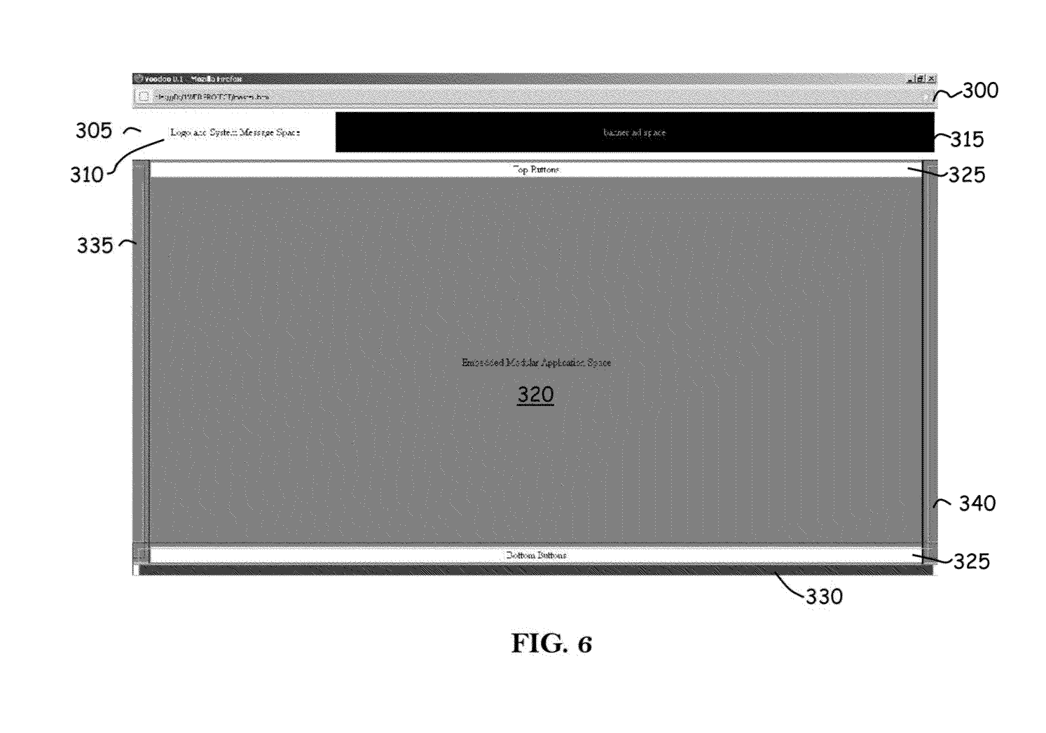

FIG. 5 is a mockup of a typical graphical user interface screen that is displayed on a user's web browser 200. This screen is considered the inventor's best mode but not exclusive method for a display of all projects that are available to the user. At the top of the display is a top section 205 with an area for logos and system messages 210, and third party “banner” advertisements 215. Directly below this area is a user status section 220 that displays either the contributor's name and last login time, or a link to the login screen, where a user can login or create a new user. In a tabular, index-able listing 225 is a list of those projects in which the user is a participant or eligible to view. Projects are categorized by levels of visibility that restrict who can view or interact with projects based upon the screen viewer's login status. Projects that the user is currently participating in are highlighted in symbolically meaningful ways, such as colors denoting normal status, awaiting messages, and critical warnings. Upon selection of a project listing entry 225 the user's web browser requests the integrated development application 300 (FIG. 6) in a separate browser window that is maximized and with all web browser toolbars and add-ons hidden. At the bottom of this screen is a section of textboxes and other interface elements 230 for searching and filtering the listing of available projects 225. On the right side of the screen is a communication section 235 where general, non-project specific communications are facilitated. This can be by messaging, discussion board style functionality, or by other means as incorporated into the application.

FIG. 6 depicts a mockup of an embodiment of a graphical user interface screen that is displayed on users' web browser 300. The screen is divided into five components based upon functional areas. The top section 305 is an area where system messages 310 are broadcast and where third party “banner” advertisement space 315 is located. Also in this space is HTML and JavaScript code for regularly refreshing just this section and passing information and commands to other sections of the rendered page so as to minimize web server 30 (FIG. 1) and database management system 20 (FIG. 1) resource usage, and prevent inadvertent disruption of imbedded development application function. The center section 320 is where the imbedded development application that is being used by the contributor at the moment is displayed. In keeping with visual application convention, at the top and bottom of this space are areas for application specific bars and buttons 325. At the bottom of the display is the project management section 330, an area devoted to project management functions such as timelines, progress charts, and an events calendar. The project management section 330 is also where contributors vote on issues and project decisions. To the left is the tools section 335 this is an area where buttons or icons that represent project specific or relevant imbedded development applications may be selected and displayed in the center section 320 of the display. User preferences, utilities, and other future enhancements are also accessed from the tools section 335. The communications section 340 is on the right side of the screen and contains functionality related to communicating with other project contributors such as messaging, voice and video chat, and other means. It will display a listing of which contributors are currently active to facilitate live meetings and other communications. These functionality sections; 330, 335, 340 “scroll out” when “moused over” or otherwise activated for use. When not in use they remain as depicted in the drawings, along the edges of the screen. This is the typical or default configuration of display sections. The arrangement of sections as well as basic style elements such as colors and fonts of the browser rendered web page are all adjustable from the user preferences functionality in the tools section 335.

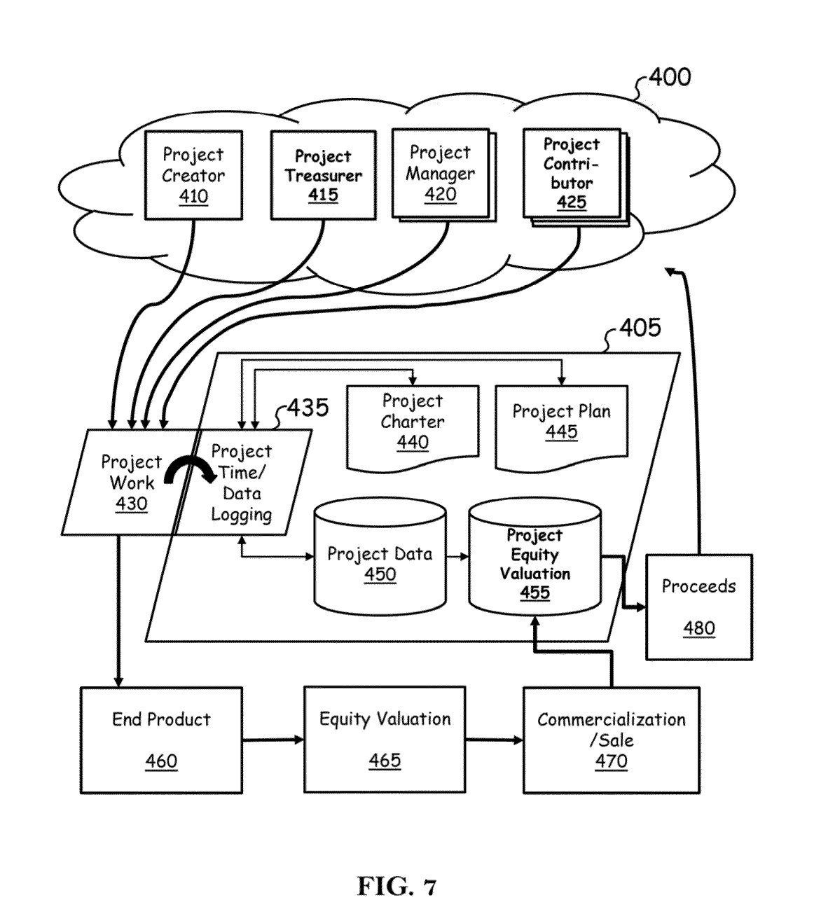

FIG. 7 Shows a simplified example to demonstrate the function of the system. A group of people decide to produce and publish a crowd sourced collection of poetry. Its members enroll in the system and agree to the user agreement and required documentation. One of them, “User A”, creates a new project and becomes the Project Creator 410. At this time, basic project information is input by the Project Creator 410. This information includes a project charter 440 which defines the goal of creating a poetry book to be published in print. The equity sharing arrangement of the project is by distributive equity and simple points for performance award. A project plan 445 is set which expects each contributing user to submit at least ten new or revised works a week for review and to weekly review all other submitted contributions from other users per week. The project due date for completion is three months. User A receives one hundred equity points and has 100% of the project's equity.

Another participant, “User B”, joins the project and volunteers to become the Project Treasurer 415. The Project Creator 410 approves the member and grants that person treasurer authority. User B receives fifty equity points for joining the project and twenty-five equity points for becoming Project Treasurer 415 for a total of seventy-five points and seventy-five points are added to the project point total making the total one hundred seventy-five points. User A has 57% and User B has 43% equity stake in project.

Two more contributors, “User C and User D”, join the project and become Project Managers 420 and after approval, these contributors have the authority to edit the project charter 440 and project plan 445. This is done in a group meeting with all project members and the final two documents are voted on and accepted by unanimous consent as the formal project charter 440 and Project Plan 445. From then on the project becomes “live”, publicly posted and accessible to other contributors. Each receives fifty equity points for joining the project and twenty-five equity points for becoming Project Managers, giving them seventy-five equity points each and one hundred and fifty points are added to the project point total making it three hundred and twenty-five points. This gives User A 30.7%, Users B, C, and D each 23.1% equity stake.

Two unaffiliated individual authors join the project and become project contributors 425, as “User E” and “User F”. These authors agree to the project charter 440 and project plan 445. They each receive fifty points and one hundred points are added to the overall point total making it four hundred and twenty-five equity points and User A has 23.5%, Users B, C, and D have 17.6%, and Users E and F have 11.7%.

A publishing company is recruited into the project as “User G” and receives its initial fifty equity points and fifty points are added to the total equity point total. The publishing company offers to publish a print version of the material in exchange for a final 30% equity stake in the project. These are approved by project officers. Because User G is providing a deferred capital input (it does not print or distribute the books until after it is written) its equity contribution and share is derived when its services are rendered at the end phase 460 of the project. This gives User G a temporary 10.5% equity stake and drops User A's equity percentage to 21%, User B, C, D to 15.7%, and Users E and F now have 10.5% equity involvement.

In order to contribute to the project User C requests the purchase of a thesaurus reference book. This is approved by the Project Treasurer and all participants who contribute funds toward that purchase receive two points in exchange. User B has the total number of points supplied by other participants deducted from their total while they have possession of the book.

User F never makes any submissions and never logs into the system nor communicates with other contributors and so by the project charter 440 rules, has points deducted from User F's total until it reaches zero when the user can be removed from the project. The same number of points are also removed from the project total points as well. This keeps point totals and percentages of equity ownership the same relative among contributors and only redistributes said ownership away from User F.

All users except for Users F and G contribute to the project via the system's project work interfaces 430, in this case using a word processing Java applet that is embedded in the web page and that shares data with the project time and data logging functions 435, that updates user point totals in the project data database 450 based on the Project Charter 440. In this case one point per word submitted and accepted. In this example each contributing user accumulates one hundred points for their inputs to the project. This puts total project equity at nine hundred and twenty-five points. User A has 21.8%. Users B and D have 19.1%. User C has 18% and a thesaurus. User E has 16.4%. User F has zero percent and has been removed from the project. User G has 5%.

When all users agree by vote that the book is complete, the project enters the End Product phase 460 and the project data files 450 are sent to User G who proceeds to print and distribute it. External to the system, User G establishes a conventional author-agent relationship with the other project contributors and uses the end equity share percentages from the project equity valuation tables 455 as a method for determining the royalty distribution of proceeds 480. This is the equity valuation phase 465 and commercialization phase 470 of the project. In this case the end percentages are; User A will have 16.9%, User B and D will have 14.2%, User C will have 13.2%, and user E will have 11.5% of whatever final proceeds or royalties result from the distribution and sale of the end product.

While the description above refers to a particular embodiment of the present invention it will be understood that it represents the basic description and method in which to implement the scope and spirit of the present invention, and that many modifications may be made without departing from the spirit thereof. The presently disclosed embodiments are to be considered illustrative and not restrictive of the scope and specific embodiment of any practical application thereof. The accompanying claims are intended to cover such modifications as would fall within the true scope and spirit of the present invention.

What is claimed is:

1. A method comprising the steps of: a process by which data is electronically inputted into a computer system that facilitates the creation, organization, and capitalization of at least one project or activity with at least one contributing entity; an organizational charter created for each said discrete project that defines the objectives, by-laws, and rules for the division of capital value of the said associated project; an organizational project plan created for each said discrete project that defines the deliverable deadlines, phase time-lines, and other time related elements of said project; an abstracted point system with which to calculate and modify the capital value of said project during the said project's life cycle; a percentage value that is calculated for each said contributing entity; an integrated development system that tracks and makes changes to said project data based upon electronic inputs and calculations; a formula for the division and dispersement of said project's equity to participating contributing entities.

2. A method set forth in claim 1, wherein a central database management system stores and accesses a plurality of relevant contributing entity and discrete project datasets.

3. A method set forth in claim 1, wherein a project is an activity, product, or specific goal.

4. A method set forth in claim 1, wherein a non-monetary variable integer number is defined to represent the total accumulated equity value of an associated project.

5. A method set forth in claim 1, wherein a contributing entity can be an individual real person, corporation, or other group which contributes land, labor, or capital to a project.

6. A method set forth in claim 1, wherein a variable is used to represent the percentage of total equity assigned to an individual contributing entity at the time of project creation and throughout the lifecycle of said individual project.

7. A method according to claim 1, wherein an organizational charter is created, defined, and inputted into the system at the time of each project creation.

8. A method according to claim 7, wherein a set of rules and mathematical algorithms are defined by said organizational charter at the time of specific project creation and input into the system.

9. A method according to claim 1, wherein an organizational project plan is created, defined, and inputted into the system at the time of each project creation.

10. A method according to claim 9, wherein said organizational project plan is used to set deliverable dates and deadlines for said specific project objectives as defined in said organizational project charter.

11. A method according to claim 1, wherein said contributing entities make capital inputs into a specific project and are programmatically recorded to the project database.

12. A method according to claim 1, where the aggregate value of an individual project is computed based upon capital inputs as modified by said organizational charter rules and applied to said project.

13. A method according to claim 1, wherein upon scheduled project milestones as set forth in the organizational charter, project equity value can be redeemed for pecuniary value.

14. A method according to claim 1, wherein upon project conclusion or conversion into a conventional corporation as set forth in the organizational charter, project equity value can be redeemed for its final pecuniary or equity value.

15. A method implemented by a programmed computer the method comprising: a graphical user interface from which a plurality of contributing entities can communicate with other contributing entities and a central coordinating database via an electronic network.

16. A method according to claim 15, wherein said contributing entities can view, interact, and modify relevant data files synchronously over an electronic network.

17. A method according to claim 15, wherein computer executable program code graphically displays said files and file manipulation tools to said contributing entities.

18. A method according to claim 15, wherein computer executable program code tracks the inputs of contributing entities and adjusts the corresponding equity value of said contributing entities.

19. A method according to claim 15, wherein computer executable program code permits a project creator or administrator to manage their associated projects and equity valuation.
